(19) United States
(12) Patent Application Publication
(10) Pub. No.: US 2009/0113935 A1
(43) Pub. Date: May 7, 2009

(54) PROCESS FOR PRODUCING GLASS BAR

(75) Inventors: Tetsuo Suzuki, Tokyo (JP); Toshiaki Tateisi, Tokyo (JP); Tetsuya Kumada, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: THE FURUKAWA ELECTRIC CO., LTD., Tokyo (JP)

(21) Appl. No.: 11/916,531

(22) PCT Filed: Oct. 23, 2006
(86) PCT No.: PCT/JP2006/321035

§ 371 Date: Dec. 5, 2007

(30) Foreign Application Priority Data
Oct. 27, 2005 (JP) 2005-312856

(51) Int. Cl. C03B 23/037

(52) U.S. Cl. 65/64

(57) ABSTRACT

Included are a reducing-heterogeneous-layer removing process of removing at least a part of a reducing heterogeneous layer in a surface of a plate glass manufactured through a float process, and a heating drawing process of heating and softening the plate glass from which at least the part of the reducing heterogeneous layer is removed in a heating furnace to draw the plate glass to a desirable thickness to form a glass strip. Thus provided is a method of manufacturing a glass strip capable of manufacturing a thin, rod-like glass strip with an excellent flatness even when a plate glass to be subjected to the heating drawing is a plate glass manufactured through the float process.

### TECHNICAL FIELD

The present invention relates to a method of manufacturing a thin, rod-like glass strip through heating drawing of thick, plate-like plate glass.

### BACKGROUND ART

Conventionally, improvements in flatness and surface roughness are very important for plate glass employed for substrates of semiconductor devices, spacers for field-effect flat panel displays, or substrates of magnetic disks. However, a float process or a casting process currently typically used as a method of manufacturing plate glass produces plate glass with low flatness when used to manufacture thin plate glass. Therefore, plate glass has to be finished to an appropriate flatness for the above use through grinding and polishing of a significant amount of a surface thereof. As a result, the plate glass after the grinding has an extremely unfavorable surface roughness.

To solve the problem as described above, the ground plate glass typically is subjected to the polishing twice, so that the surface roughness is 0.5 nm after the first polishing, and approximately 0.1 nm after the second polishing. It is expected that a third polishing will be required in addition to the above, since there will be a demand for a product with higher precision in the next generation. Therefore, an endeavor to improve the flatness of the plate glass only through the grinding and polishing will end up in more time and work for grinding and polishing, which eventually leads to a higher manufacturing cost.

In view of the above, a method is devised to manufacture thin plate glass of a desirable thickness using base material plate glass with a predetermined thickness and an improved surface roughness and by heating the base material plate glass to soften the same and drawing the softened plate glass (see patent Document 1).

Patent Document 1: Japanese Patent Application Laid-Open No. H11-199255

### DISCLOSURE OF INVENTION

### Problem to be Solved by the Invention

However, when the manufacturing method described in Patent Document 1 is employed to manufacture a glass strip by heating, softening, and drawing plate glass manufactured through the float process, the resulting glass strip warps in a convex manner, whereby flatness deteriorates significantly.

The present invention is made in view of the foregoing, and an object of the present invention is to provide a method of manufacturing a glass strip according to which a thin, rod-like glass strip with an excellent flatness can be manufactured even when plate glass manufactured through the float process is subjected to heating drawing.

### Means For Solving Problem

To solve the problems as described above, and to achieve an object, a method of manufacturing a glass strip according to the present invention includes removing at least a part of a reducing heterogeneous layer in a surface of plate glass manufactured through float process, and heating drawing for heating and softening the plate glass from which at least a part of the reducing heterogeneous layer is removed in a heating furnace to draw the plate glass to a desirable thickness to form a glass strip.

Further, in the method of manufacturing a glass strip according to the present invention, 70% or more in thickness of the reducing heterogeneous layer may be removed in the removing.

Still further, in the method of manufacturing a glass strip according to the present invention, the plate glass may be immersed in a hydrofluoric-acid-based etching solution and at least a part of the reducing heterogeneous layer is removed in the removing.

### EFFECT OF THE INVENTION

According to the present invention, removal of at least a part of a reducing heterogeneous layer in a surface of plate glass manufactured through float process results in an elimination of difference in composition between two surfaces of the plate glass. Therefore, no stress difference is generated between two surfaces of the plate glass in a process of heating drawing, whereby warpage of the glass strip can be suppressed even when the plate glass manufactured through the float process is subjected to heating drawing, whereby a glass strip with an excellent flatness can be manufactured.

### BRIEF DESCRIPTION OF DRAWINGS

FIG. 1 is a flowchart of a manufacturing process of a method of manufacturing a glass strip according to an embodiment of the present invention.

FIG. 2 is a schematic view for explaining a reducing-heterogeneous-layer removing process using an etching solution.

FIG. 3 is a schematic view for explaining a warpage amount.

FIG. 4 is a graph showing results of measurements of Sn concentration near a surface of float plate glass according to SIMS analysis.

FIG. 5 is a table of conditions for reducing-heterogeneous-layer removal, thickness of a removed part of a reducing heterogeneous layer, a rate of reducing-heterogeneous-layer removal in examples, and resulting surface roughness and warpage amount in examples and a comparative example.

FIG. 6 is a graph of relation between rates of reducing-heterogeneous-layer removal and warpage amounts of glass strips in examples 1 to 15.

### EXPLANATIONS OF LETTERS OR NUMERALS

1 Base material plate glass
2 Reducing heterogeneous layer
3 Etching solution tank
4 Etching solution
5 Bottom surface
6 Top surface
7 Warpage amount
8 Center line
9 Distance between two points away from each other by unit length
10 Glass strip

### BEST MODE(S) FOR CARRYING OUT THE INVENTION

Exemplary embodiments of a method of manufacturing a glass strip according to the present invention will be described in detail below with reference to the accompanying drawings. The present invention is not limited by the embodiments.

### Embodiment

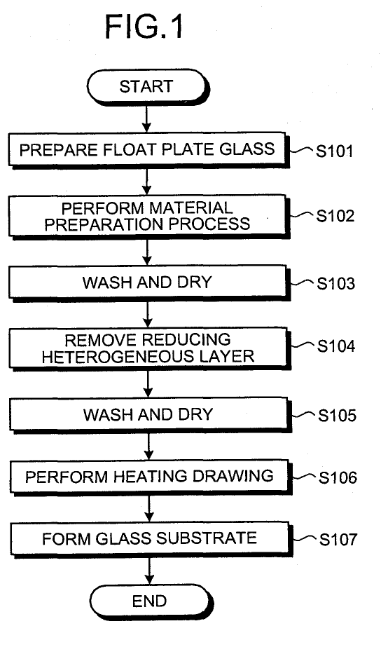

FIG. 1 is a flowchart of a manufacturing process in the method of manufacturing a glass strip according to one embodiment of the present invention. In FIG. 1, a plate-like glass manufactured through the float process (i.e., float plate glass) is prepared (step S101). A float bath is filled with molten metallic tin, and molten glass is poured onto the bath of liquid tin, whereby a float plate glass is formed. The float process allows for stable low-cost mass production of large-area plate glass. Since a lower surface (i.e., bottom surface) of the plate glass is brought into contact with molten tin in the manufacturing process, metallic components enter into a surface layer of the bottom surface as ions, whereby a reducing heterogeneous layer containing metallic ions is formed in the float plate glass. Thickness of the reducing heterogeneous layer containing metal such as tin varies according to glass composition, though known to be in a range of approximately a few μm to 100 μm.

Next, the float plate glass is cut into desirable size, and base material plate glass is cut out in a material preparation process (step s102). Shape of the base material plate glass is, for example, 328 mm in width, 5 mm in thickness, and 1.5 m in length.

Next, the base material plate glass is washed and dried in a washing/drying process, whereby foreign matters and the like adhered to the surface in processes such as the material preparation process is removed (step S103). Then, at least a part of the reducing heterogeneous layer in the surface of the base material plate glass is removed (step S104). Through the removal of at least a portion of the reducing heterogeneous layer, difference in composition between two surfaces of the plate glass, i.e., between an upper surface (i.e., top surface) and the bottom surface of the plate glass can be eliminated.

The reducing-heterogeneous-layer removing process shown in step S104 may be realized through sandblasting according to which the surface of the base material plate glass is polished by glass beads blown onto the surface of the base material plate glass by compressed air or through ordinary polishing using an abrasive pad and abrading agent. Preferably, however, at least a portion of the reducing heterogeneous layer is removed through immersion of the base material plate glass in a hydrofluoric-acid-based etching solution. In the etching using the hydrofluoric-acid-based agent, surface roughness of the plate glass is not deteriorated, and the removal of the reducing heterogeneous layer can be achieved with a simple facility without the constraint on the area of the plate glass. Usable etching solution is, for example, hydrofluoric acid, a liquid mixture of hydrofluoric acid and sulfuric acid, or a liquid mixture of hydrofluoric acid, ammonium fluoride, and sulfuric acid.

Then, the base material plate glass is washed and dried in the washing/drying process, whereby foreign matters and the like adhered to the surface during processes such as the reducing-heterogeneous-layer removing process are removed (step S105).

The base material plate glass from which at least a part of the reducing heterogeneous layer is removed is subjected to a heating drawing process in which the base material plate glass is heated and softened in a heating furnace to be drawn to a desirable thickness to form a glass strip (step S106). Since at least a part of the reducing heterogeneous layer is removed in step S104, the difference in composition between the two surfaces of the base material plate glass is eliminated, whereby no stress difference is generated between the two surfaces of the base material plate glass during the heating drawing process. Therefore, even when the float plate glass is subjected to heating drawing, warpage of the glass strip is suppressed, whereby a glass strip with an excellent flatness can be manufactured. The heating drawing process can be performed according to the method described in Patent Document 1, for example.

Thus, the glass strip with an excellent flatness is obtained. The obtained glass strip is formed into a glass substrate of necessary shape, for example, to be used as a substrate of a semiconductor device, a spacer for a flat panel display, a substrate for a magnetic disk, or the like (step S107). Since the glass strip with an excellent flatness manufactured in the method of manufacturing according to the present invention has little warpage, the glass strip can be suitably employed as a glass substrate or the like employed for the uses listed above that is required to have a high flatness.

Examples of the method of manufacturing a glass strip according to the present invention will be described in detail below. The present invention, however, is not limited by the examples.

### Examples 1 to 21 & Comparative Example

As an example of the present invention, a float plate glass of borosilicate glass (TEMPAX Float® manufactured by Schott AG) is prepared. Following the manufacturing process shown in FIG. 1, each of the material preparation process, washing/drying process, reducing-heterogeneous-layer removing process, and washing/drying process is performed to manufacture a base material plate glass of 328 mm in width, 5 mm in thickness, and approximately 1.5 m in length. The base material plate glass is subjected to heating drawing, and a glass strip of 25 mm in width and 0.38 mm in thickness is manufactured. The reducing heterogeneous layer is removed as follows.

<Removal of Reducing Heterogeneous Layer through Etching>

An etching bath is filled with an etching solution. The base material plate glass is immersed in the etching solution for a predetermined time period. The used etching solution is a liquid mixture of hydrofluoric acid and sulfuric acid, or a liquid mixture of hydrofluoric acid, ammonium fluoride, and sulfuric acid.

### <Removal of Reducing Heterogeneous Layer Through Sandblasting>

Glass beads are blown onto the surface of the base material plate glass by compressed air, and an entire surface of the plate glass is polished.

### <Removal of Reducing Heterogeneous Layer Through Mechanical Polishing>

The base material plate glass is polished by a two-side polishing machine (in which abrasive member is a soft suede pad and abrading agent is colloidal silica) over the entire surface. Since it is difficult to polish a large-area base material plate glass due to equipment constraints, a base material plate glass of 328 mm in width, 5 mm in thickness, and 400 mm in length is used. The length is shorter than the base material plate glass mentioned earlier.

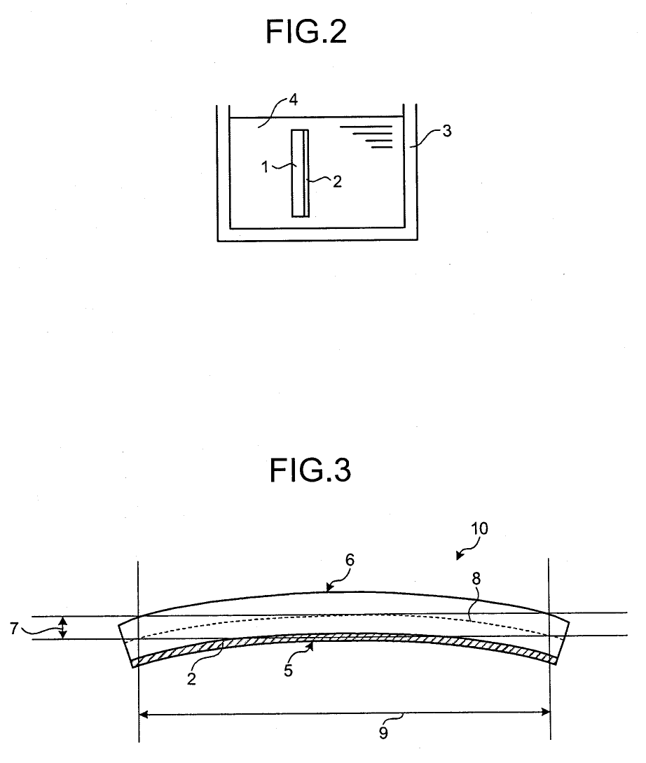

The removal of the reducing heterogeneous layer through the etching is described in detail. FIG. 2 is a schematic view for explaining the reducing-heterogeneous-layer removing process using the etching solution employed in the examples 1 to 19. An etching bath 3 is filled with an etching solution 4 such as a liquid mixture of hydrofluoric acid and sulfuric acid, or a liquid mixture of hydrofluoric acid, ammonium fluoride, and sulfuric acid. A base material plate glass 1 is immersed in the etching solution and a part or a whole of a reducing heterogeneous layer 2 is removed. Thickness of the removed reducing heterogeneous layer can be adjusted through control of various conditions such as a composition of the etching solution such as concentration of hydrofluoric acid, etching time, and temperature of etching solution. In the examples 1 to 15, the etching solution is a liquid mixture of hydrofluoric acid and sulfuric acid, the etching time is 0.2 to 40 minutes, and the temperature of the etching solution is 25° C. In the examples 16 to 19, the etching solution is a liquid mixture of hydrofluoric acid, ammonium fluoride, and sulfuric acid, the etching time is 10 to 100 minutes, and the temperature of the etching solution is 25° C.

On the other hand, as a comparative example, a float plate glass of the same type as those employed in the examples is prepared. Each of the material preparation process, washing/drying process, and the like is performed, and a base material plate glass of 328 mm in width, 5 mm in thickness, and approximately 1.5 m in length is manufactured. The base material plate glass is subjected to heating drawing, and a glass strip of 25 mm in width and 0.38 mm in thickness is manufactured.

In the examples 8, 12 to 21, surface roughness of the base material plate glass after the removal of the reducing heterogeneous layer is measured by an atomic force microscope (AFM), whereas in the comparative example, surface roughness of the base material plate glass after the washing and drying is measured by AFM. Further, warpage of the glass strip after heating drawing is evaluated in each of the examples and comparative example.

As an indicator of the warpage of the glass strip, a warpage amount is used. FIG. 3 is a schematic view for explaining the warpage amount, and shows a section of a glass substrate of a desirable shape formed from a glass strip 10 after heating drawing. The glass strip 10 has a reducing heterogeneous layer 2 formed on a bottom surface 5. A warpage amount 7 of the glass strip 10 is height difference between a highest point and a lowest point taken along a vertical direction of a center line 8 of a thickness direction of the glass strip between two points away from each other by a unit length on a substrate surface when the glass strip 10 cut out as a substrate by a necessary area is placed on a horizontal surface.

The warpage amount is measured and evaluated by a surface texture measurement device (CS5000 manufactured by Mitutoyo Corporation). The distance between the two points is set to 20 mm. A desired value of the warpage amount varies according to the use, and is 2 μm or less in the case of a glass substrate for a magnetic disk, and more preferably, 1 μm or less, for example.

(Results of Comparison)

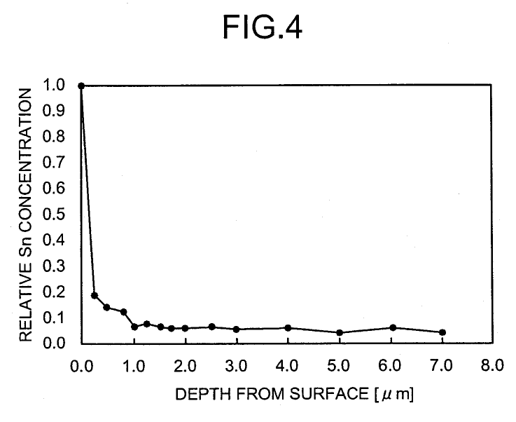

FIG. 4 is a graph showing results of measurements of Sn (tin) concentration by secondary ion mass spectrometry (SIMS) near the bottom surface of the float plate glass used in the examples and the comparative example. The horizontal axis represents depth from the surface, whereas the vertical axis represents relative Sn concentration. In the float plate glass employed above, Sn concentration is highest near the surface, and decreases away from the surface. At a 2-μm-deep point from the surface, Sn concentration reaches saturation and takes a background value. Therefore, the thickness of the reducing heterogeneous layer is estimated to be 2 μm.

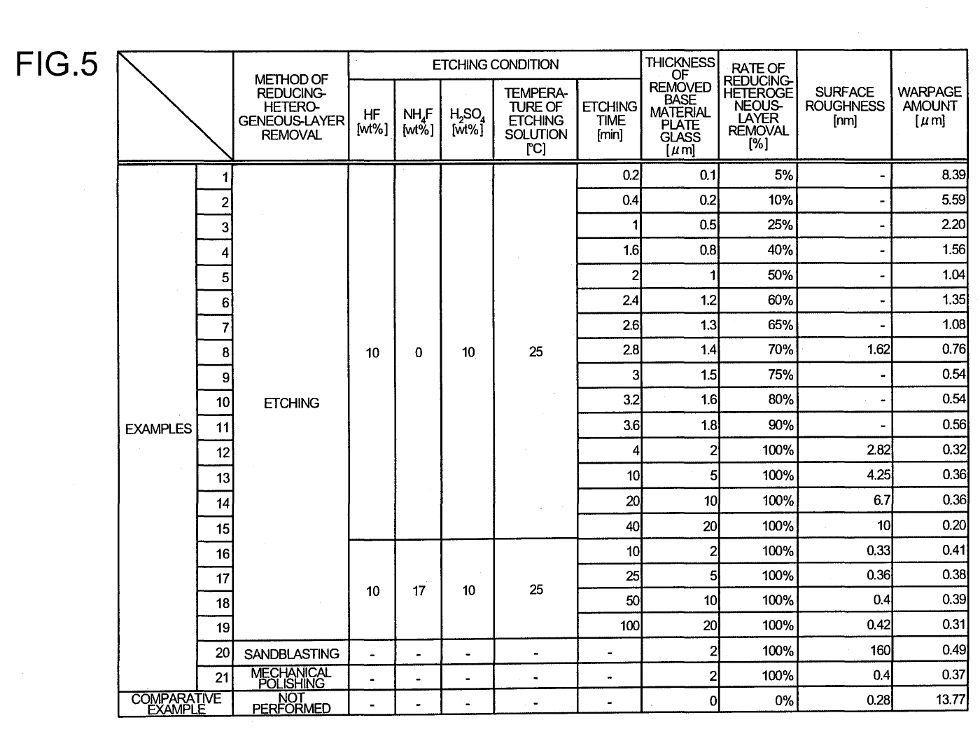

FIG. 5 is a table showing manners of reducing-heterogeneous-layer removal, the thickness of removed base material plate glass, rates of reducing-heterogeneous-layer removal of the examples, and resulting surface roughness and warpage amounts in the examples and the comparative example. The rate of reducing-heterogeneous-layer removal means a ratio of the thickness of the reducing heterogeneous layer after the removal to the thickness of the reducing heterogeneous layer before the removal, as represented in percentage. In the examples 13 to 15 and 17 to 19, thickness of a portion removed through the etching is equal to or larger than the thickness of the actual reducing heterogeneous layer. When the examples 1 to 21 are compared with the comparative example, it can be seen that the warpage amount of the glass strip subjected to heating drawing is significantly reduced due to the removal of the reducing heterogeneous layer.

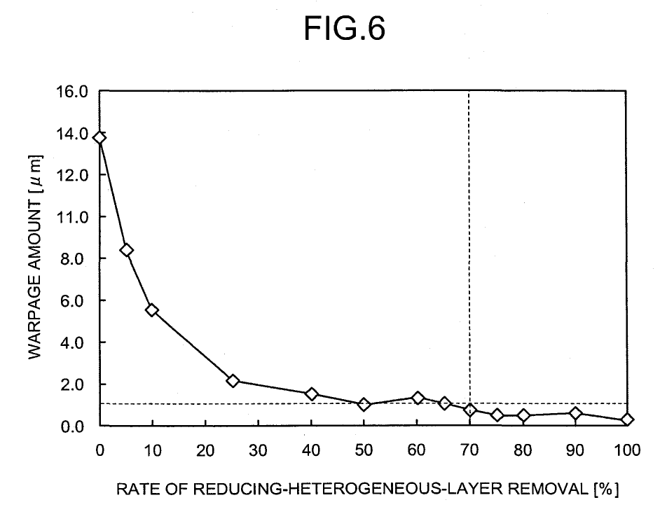

FIG. 6 is a graph showing a relation between the rate of reducing-heterogeneous-layer removal and the warpage amount of the glass strip in the examples 1 to 15. It can be seen from the graph, that the warpage amount decreases as the rate of reducing-heterogeneous-layer removal increases, until the decrease in the warpage amount becomes substantially flat as the rate of reducing-heterogeneous-layer removal reaches 50%. Improvement appears when the rate of reducing-heterogeneous-layer removal reaches 70%, and the warpage amount becomes 1 μm or less.

Thus, there is a correlation between the warpage amount of the glass strip and the rate of reducing-heterogeneous-layer removal. Therefore, the reducing heterogeneous layer may be removed by a thickness that allows for a desirable warpage amount. Preferably, when 50% or more of the thickness of the reducing heterogeneous layer is removed, or more preferably, when 70% or more of the thickness of the reducing heterogeneous layer is removed, the warpage of the glass strip is efficiently suppressed, whereby a glass strip with an excellent flatness can be obtained.

In the example 20 where the reducing heterogeneous layer is removed through sandblasting, an advantageous effect of the present invention, i.e., suppression of warpage and improved flatness are obtained. However, the surface roughness after the removal of the reducing heterogeneous layer is approximately 160 nm, and relatively high. On the other hand, in the example 21 where the reducing heterogeneous layer is removed through mechanical polishing, a high manufacturing cost is required to remove the reducing heterogeneous layer while maintaining a preferable surface roughness. In addition, there is a constraint on a polishable area of the base material plate glass due to equipment constraints, and in some cases, a base material plate glass of a desirable dimension may not be processed.

On the other hand, when the examples 1 to 19 and the examples 20 and 21 are compared, it can be found that when chemical polishing is performed through the etching with the hydrofluoric-acid-based etching solution, surface roughness of the base material plate glass is more preferable in comparison with that obtained when the sandblasting is performed, and in addition, a desirable amount of polishing can be realized in a simple equipment as shown in FIG. 2. Further, when the liquid mixture of hydrofluoric acid and sulfuric acid is employed as the etching solution as in the examples 12 to 15, the surface roughness deteriorates as the etching time increases. On the other hand, when the liquid mixture of hydrofluoric acid, ammonium fluoride, and sulfuric acid is employed as the etching solution, the surface roughness of the surface of the base material plate glass deteriorates little even when the etching time increases, thus providing preferable results.

It is supposed that the warpage of the glass strip subjected to the heating drawing is suppressed through the removal of the reducing heterogeneous layer for the following reasons. When the reducing heterogeneous layer exists at the bottom surface of the float plate glass, the composition, softening temperature, viscosity, and the like slightly differ at the top surface and the bottom surface. Therefore, the stress difference is generated between the two surfaces during the heating drawing process, resulting in a glass strip with a convex section bulging towards the top surface side. When the reducing heterogeneous layer is removed, the difference in composition between the two surfaces of the plate glass is eliminated, and the stress difference is not generated in the process of heating drawing, whereby the warpage of the glass strip can be suppressed. The inventors of the present invention find the foregoing by repeatedly conducting experiments to find a cause of warpage.

The present invention is not limited by the embodiments described above. The embodiments are described above merely by way of illustration, and anything that has substantially the same configuration with the technical concept described in appended claims and that has the same advantageous effects are deemed inclusive in the technical scope of the present invention.

For example, type, size, thickness, and the like of the float plate glass used in the present invention are not particularly limited. A material of the plate glass may be, for example, aluminosilicate glass, soda-lime glass, soda aluminosilicate glass, alumino-borosilicate glass, borosilicate glass, physical tempered glass subjected to processing such as air-cooling or liquid-cooling, or chemical tempered glass.

Further, with regard to the etching solution used to remove the reducing heterogeneous layer of the plate glass, etching power (i.e., etching speed) may be adequately adjusted by addition of a buffering agent such as ammonium fluoride, potassium fluoride, or silicofluoric acid into a hydrofluoric-acid-based solution. Further, other acid (such as hydrofluoric acid, sulfuric acid, hydrochloric acid, or nitric acid), commercially available washing agent (such as neutral detergent, surface-active agent, or alkaline detergent) may be added to enhance an etching effect (washing effect) and the like. In the examples, the reducing heterogeneous layer is removed after the material preparation process, though the removal of the reducing heterogeneous layer may be performed prior to the material preparation process.

Further, the surface roughness resulting from the etching and takt time of the processes vary according to the types of the glass. Therefore, etching conditions such as the concentration of hydrofluoric acid in the etching solution, etching time, and temperature of the solution may preferably be adjusted according to the types of the used glass.

### INDUSTRIAL APPLICABILITY

The method of manufacturing a glass strip according to the present invention is suitable for manufacture of a plate glass used as substrates of semiconductor devices, spacers for field-effect flat panel displays, substrates for magnetic disks, and the like.

1. A method of manufacturing a glass strip comprising:
removing at least a part of a reducing heterogeneous layer in a surface of a plate glass manufactured through float process; and
heating drawing for heating and softening the plate glass from which at least a part of the reducing heterogeneous layer is removed in a heating furnace to draw the plate glass to a desirable thickness to form a glass strip.

2. The method of manufacturing a glass strip according to claim 1, wherein
70% or more in thickness of the reducing heterogeneous layer is removed in the removing.

3. The method of manufacturing a glass strip according to claim 1, wherein
the plate glass is immersed in a hydrofluoric-acid-based etching solution and at least a part of the reducing heterogeneous layer is removed in the removing.

4. The method of manufacturing a glass strip according to claim 2, wherein
the plate glass is immersed in a hydrofluoric-acid-based etching solution and at least a part of the reducing heterogeneous layer is removed in the removing.
